(19) United States
(12) Patent Application Publication
(10) Pub. No.: US 2015/0263876 A1
(43) Pub. Date: Sep. 17, 2015

(54) TRANSMISSION CIRCUIT FOR SPECTRALLY PRECODED ORTHOGONAL FREQUENCY DIVISION MULTIPLE ACCESS WITH INTERLEAVED SUBCARRIER ALLOCATION

(71) Applicant: National Taiwan University, Taipei (TW)

(72) Inventors: Char-Dir CHUNG, Taipei (TW); Wei-Chang CHEN, Taipei (TW)

(73) Assignee: NATIONAL TAIWAN UNIVERSITY, Taipei (TW)

(21) Appl. No.: 14/537,837

(22) Filed: Nov. 10, 2014

(30) Foreign Application Priority Data
Mar. 13, 2014 (TW) 103109017

(51) Int. Cl. H04L 27/26; H04L 5/00

(52) U.S. Cl. CPC H04L 27/2626; H04L 27/2602; H04L 5/003

(57) ABSTRACT

One transmission circuit for spectrally precoded orthogonal frequency division multiple access with interleaved subcarrier allocation includes a data generator, a correlative precoder, a subcarrier allocator and an OFDM modulator. The feature of the correlative spectral precoder is a precoding matrix having a lower triangular band matrix with a correlative bandwidth B. When the transmitter circuit satisfies a single-user orthogonal frequency division multiple access (OFDMA) protocol, the baseband power spectral density function S(f) of the transmission signal s(t) satisfies a following equation:

$$S ( f ) = \frac{{ρ}^{2} T}{2} {\sum }_{u = 0}^{U - 1} {sinc}^{2} ( {z}_{n} ) {\vert {\sum }_{k = 0}^{∞} {{Q}^{k} ( 1 + {2}^{- I} )}^{k} {z}_{u}^{- k} {D}_{m}^{( k )} \vert}^{2}$$

wherein zᵤ is a linear function of the frequency f, and Dₘ₍ₖ₎=Σₙ₌₀^{P-1}G_{n,m}n^{k} is correlative to the precoding matrix G;
and when the precoding matrix G satisfies a constraint: for all mε{0, 1, . . . , M−1}, kε{0, 1, . . . , L−1}, Dₘ^{(k)}=0; for some m, Dₘ^{(L)}≠0, S(f) is then further expressed as:

$$S ( f ) = \frac{{ρ}^{2} T}{2 {π}^{2}} {\sum }_{u = 0}^{U - 1} {sin}^{2} ( π {z}_{u} ) {\sum }_{k = 0}^{∞} {{Q}^{2 L + k} ( 1 + {2}^{- I} )}^{2 L + k} {z}_{u}^{- ( 2 L + 2 + k )} {Δ}_{k}$$

wherein the spectral coefficient Δₖ is defined as Δₖ=Σₖ_{₁}₊ₖ_{₂}_{=2L+K}^{K}^{¹}^{,k}^{²}^{≧L}Σₘ₌₀^{M-1}Dₘ^{(k}^{¹}⁾Dₘ^{(k}^{²}⁾.

### CROSS-REFERENCE TO RELATED APPLICATIONS

The entire contents of Taiwan Patent Application No. 103109017, filed on Mar. 13, 2014, from which this application claims priority, are incorporated herein by reference.

### BACKGROUND OF THE INVENTION

1. Field of the Invention

The present invention generally relates to an orthogonal frequency division multiple access (OFDMA) system. More particularly, the present invention relates to orthogonal frequency-division multiple access with interleaved subcarrier allocation (IOFDMA).

2. Description of Related Art

In the field of communications, the orthogonal frequency division multiplexing (OFDM) system has been widely used in wireless communications because the OFDM system has high spectral efficiency and good robustness against multipath fading channels. Because the OFDM system has multiple subcarriers, different users can use different subcarrier to share the total bandwidth, which is called orthogonal frequency division multiple access (OFDMA) system.

As shown in FIG. 1A, in the OFDMA system, the system bandwidth is composed of multiple subchannels, and each subchannel is composed of multiple subcarriers. The subchannel of the OFDMA can be made up by a plurality of continuous subcarriers or interleaved subcarriers. If the continuous transmission method is used in the subchannel allocation, such as the subchannel being composed by way of the subcarriers 1˜10, 11˜20 and 21˜30, it would be unable to successfully decode the original data at the receiving end when a part of the neighboring subcarriers are damaged at the same the time. For example, in the subchannel 1, when a problem occurs in a plurality of neighboring subcarriers 2˜6, it may be unable to perform decoding operation successfully when the data is transmitted to the receiving end by the subchannel 1.

As shown in FIG. 1B, a block diagram for a spectrally precoded OFDMA system is illustrated according the prior art. A transmission system 1 includes a transmitter circuit Tx and a receiver circuit Rx. The transmitter circuit Tx includes a data generator 110, a spectral precoder 120, a subcarrier allocator 130 and a OFDM modulator 140. The receiver circuit Rx includes an OFDM demodulator 150, a subcarrier deallocator 160, a spectral decoder 170 and a data receiver 180.

The data generator 110 is configured to generate an input symbol vector d, which includes M symbols, in 1-th signal time. The spectral precoder 120 is configured to perform a spectral precoding operation on the input symbol vector d, in order to generate a precoded symbol vector b. The subcarrier allocator 130 is configured to perform a subcarrier allocating operation on the precoded symbol vector, in order to generate data transmission vector x. The OFDM modulator 140, such as a cyclic prefix (CP) OFDM modulator, is configured to generate a transmission signal s(t) in a transmission period T for transmitting each data vector x. As for the detailed OFDMA system structure, it may be found in the content of Taiwan Patent No. 1397269.

As shown in FIG. 1C, a schematic diagram of the bandwidth of the OFDMA system with the spectral sidelobes. In the OFDMA system, the large spectral sidelobes incur remarkable adjacent channel interference, so as to generate a serious multi-user interference to reduce the system effectiveness.

The conventional OFDMA systems use the methods, such as wave shaping, frontend filter and windowing, to suppress the sidelobes. However, the power spectral sidelobes of the transmission signal, which generated by these methods, decay as f⁻², where f is frequency in Hz.

In the Taiwan Patent mentioned above, the OFDMA system applies the precoder to ensure that the sigal has fast decaying spectral sidelobes, and the OFDMA system includes a correlative spectral precoder or an orthogonal spectral precoder. However, although the orthogonal spectral precoder of the prior art can also provide power spectral sidelobes decaying faster than f⁻², it still has the problem of very high complexity in realizing the spectral precoder.

Moreover, although the correlative spectral precoder of the prior art can also provide power spectral sidelobes decaying faster than f⁻², however a need has thus arisen to propose an improved correlative spectral precoder with a better power spectral sidelobe suppression capability.

### SUMMARY OF THE INVENTION

In view of the foregoing, an embodiment of the present invention provides a transmission circuit for spectrally precoded orthogonal frequency division multiple access with interleaved subcarrier allocation including a data generator, a correlative precoder, a subcarrier allocator and an OFDM modulator. The data generator is configured to provide an input symbol vector d. The correlative precoder includes a precoding matrix G, which is a lower triangular band matrix with a correlative bandwidth B. The correlative precoder performs a spectral precoding operation on the input symbol vector d according to the precoding matrix G, in order to generate a precoded symbol vector b. The precoded symbol vector b includes a plurality of vector elements, and the vector elements are correlative with each other, and the precoded symbol vector b satisfies an equation: b=G×d. The subcarrier allocator is configured to perform an interleaved subcarrier allocation on the precoded symbol vector b according to a subcarrier allocation matrix, in order to generate a data transmission vector x. The OFDM modulator is configured to generate a transmission signal s(t) in a transmission period for transmitting the data vector x. When the transmitter circuit satisfies a single-user orthogonal frequency division multiple access (OFDMA) protocol, the baseband power spectral density S(f) of the transmission signal s(t) satisfies a following equation:

$$S ( f ) = \frac{{ρ}^{2} T}{2} {\sum }_{u = 0}^{U - 1} {sinc}^{2} ( {z}_{n} ) {\vert {\sum }_{k = 0}^{∞} {{Q}^{k} ( 1 + {2}^{- I} )}^{k} {z}_{u}^{- k} {D}_{m}^{( k )} \vert}^{2}$$

wherein zᵤ is a linear function of the frequency f, and Dₘ^{(k)}=Σₙ₌₀^{P-1}G_{n,m}n^{k} is related to the precoding matrix G;
and when the precoding matrix G satisfies a constraint: for all mε{0, 1, . . . , M−1}, kε{0, 1, . . . , L−1}, Dₘ^{(k)}=0; for some m, Dₘ^{(L)}≠0. Then, S(f) can be further expressed as:

$$S ( f ) = \frac{{ρ}^{2} T}{2 {π}^{2}} {\sum }_{u = 0}^{U - 1} {sin}^{2} ( π {z}_{u} ) {\sum }_{k = 0}^{∞} {{Q}^{2 L + k} ( 1 + {2}^{- I} )}^{2 L + k} {z}_{u}^{- ( 2 L + 2 + k )} {Δ}_{k}$$

wherein the spectral coefficient Δk is defined by Δₖ=Σₖ_{₁}₊ₖ_{₂}_{=2L+k}^{k}^{¹}^{,k}^{²}^{≧L}Σₘ₌₀^{M-1}Dₘ^{(k}^{¹}⁾Dₘ^{(k}^{²}⁾. According to the above equation, the OFDMA signal, which is generated from the transmitter circuit, has spectral sidelobes decaying as f^{2L-2}. Furthermore, the correlative spectral precoder of the present invention not only satisfies the above condition but also provides the smallest dominant spectral coefficient Δ₀. Therefore, it provides better sidelobe suppression capability than the traditional correlative spectral precoder.

Moreover, the present invention provides another transmission circuit for spectrally precoded orthogonal frequency division multiple access with interleaved subcarrier allocation, including a data generator, an orthogonal precoder, a subcarrier allocator and a OFDM modulator. The data generator is configured to provide an input symbol vector d. The orthogonal precoder is configured to perform a spectral precoding operation on the input symbol vector d according to a plurality of subprecoding matrices Gₖ, kε{1, 2, . . . , L}, in order to generate a precoded symbol vector b, and the column vectors of the subprecoding matrices Gₖ are orthogonal, which satisfy Gₖ^{h}Gₖ=I, and the precoded symbol vector b satisfies an equation: b=G×d=G_{L}×G_{L-1}× . . . ×G₁×d. The subcarrier allocator is configured to perform an interleaved subcarrier allocation on the precoded symbol vector b according to a subcarrier allocation matrix, in order to generate a data transmission vector x. The OFDM modulator is configured to generate a transmission signal s(t) in a transmission period, so as to transmit the data vector x; when the transmitter circuit satisfies a single-user orthogonal frequency division multiple access (OFDMA) protocol, the baseband power spectral density S(f) of the transmission signal s(t) satisfies a following equation:

$$S ( f ) = \frac{{ρ}^{2} T}{2} {\sum }_{u = 0}^{U - 1} sin {c}^{2} ( {z}_{u} ) {\vert {\sum }_{k = 0}^{∞} {{Q}^{k} ( 1 + {2}^{- I} )}^{k} {z}_{u}^{- k} {D}_{m}^{( k )} \vert}^{2}$$

when the subprecoding matrices G₁˜G_{L} satisfies a constraint: (Π_{k=L}^{L-l+1}Gₖ)^{t}eₗ₋₁=0, for all /ε{1, 2, . . . , L}, wherein eₗ=[0^{l}, 1^{l}, . . . , (P−1)^{l}]^{t}; the transmission signal s(t), which is generated from the transmitter circuit and satisfies the OFDMA protocol, has spectral sidelobes decaying as f^{2L-2}, wherein L is a positive integer.

### BRIEF DESCRIPTION OF THE DRAWINGS

FIG. 1A illustrates the system bandwidth composition of the OFDMA system;

FIG. 1B illustrates the spectrally precoded OFDMA system of the prior art;

FIG. 1C illustrates the spectral sidelobe problem of the OFDMA system;

FIG. 2A illustrates the interleaved subcarrier allocation scheme for IOFDMA according to an embodiment of the present invention;

FIG. 2B illustrates a block diagram for the spectrally precoded orthogonal frequency-division multiple access with interleaved subcarrier allocation system according to an embodiment of the present invention;

FIG. 2C illustrates the comparison of sidelobe suppression capability between the invented spectrally precoded IOFDMA and the spectrally precoded IOFDMA of the prior art;

FIG. 3A illustrates a block diagram of another spectrally precoded IOFDMA system according to an embodiment of the present invention;

FIG. 3B illustrates the multiple-stage structure of the orthogonal precoder of the present invention;

FIG. 4A illustrates a comparison chart for the out-of-band power fraction in a certain range between the correlative spectral precoder of the prior art and the correlative spectral precoder of the present invention; and

FIG. 4B illustrates a comparison chart of the average bit error rate of the spectral precoder of the prior art and the orthogonal spectral precoder of the present invention.

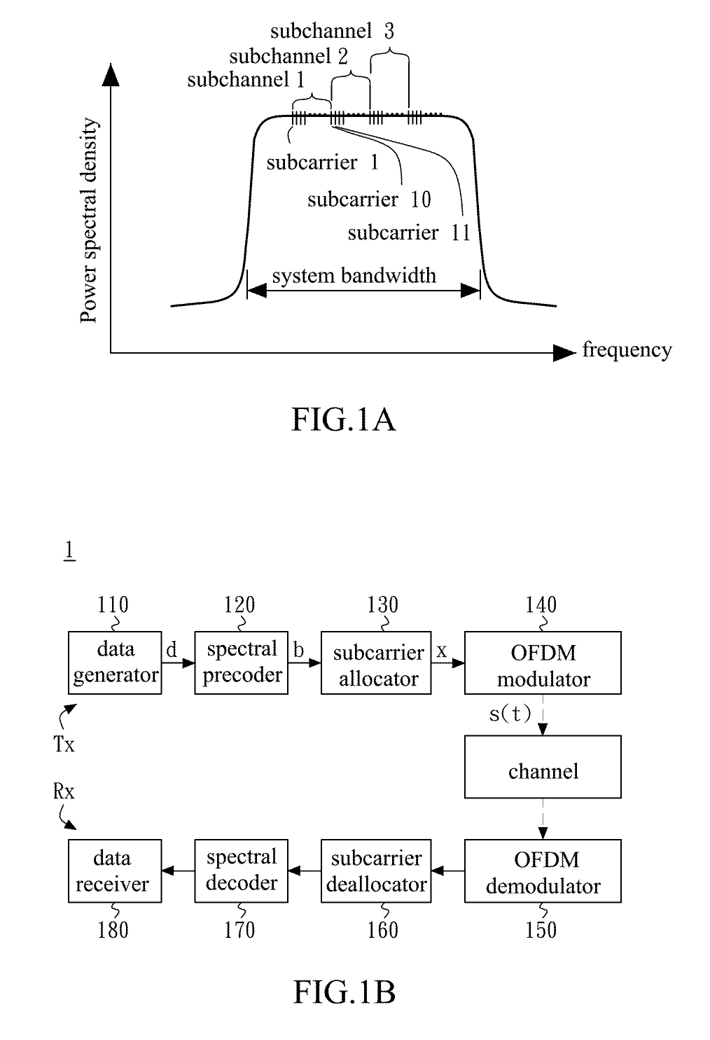

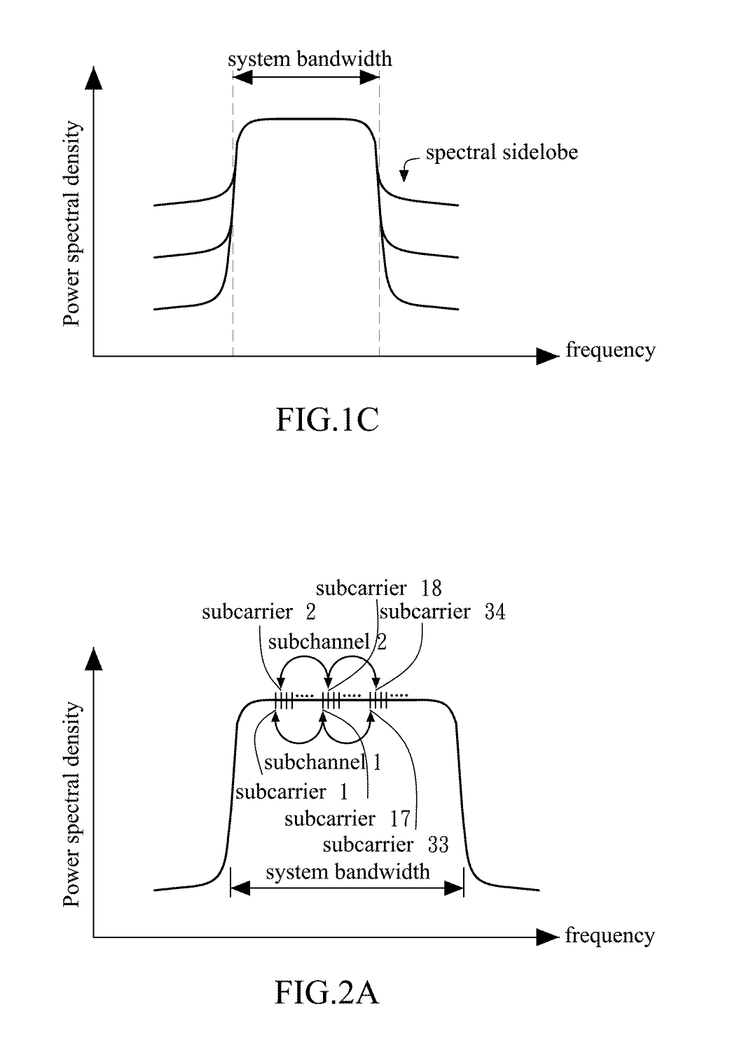

### DETAILED DESCRIPTION OF THE INVENTION

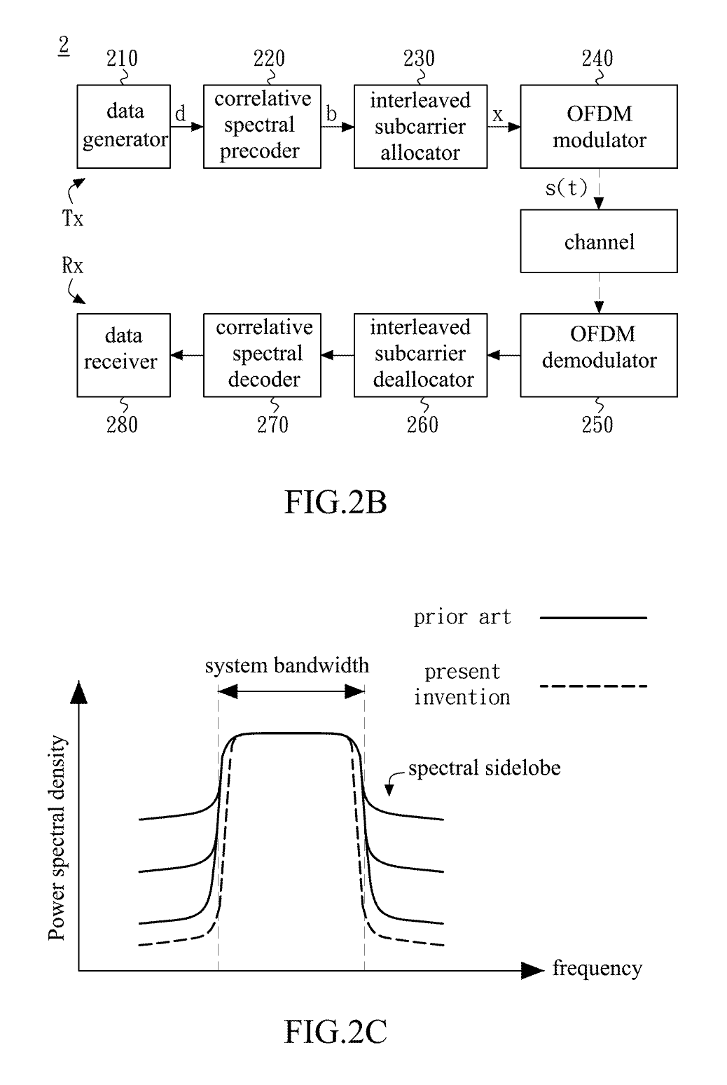

As shown in FIG. 2A, an IOFDMA system is illustrated according to an embodiment of the present invention. In an embodiment of the present invention, the subcarriers can be transmitted to a receiving end by the interleaved allocation, such as 1, 17, 33, 49 . . . , but the present invention is not limited thereto. This interleaved subcarrier allocation can provide a better frequency diversity effect than the continuous subcarrier allocation, so that it may achieve a better error performance.

Referring to FIG. 2B, a block diagram for the spectrally precoded orthogonal frequency-division multiple access with interleaved subcarrier allocation (spectrally precoded IOFDMA) system is illustrated according to an embodiment of the present invention. The spectrally precoded IOFDMA system 2 includes a channel, a transmitter circuit (TX) and a receiver circuit (RX). The Tx includes a data generator 210, a correlative spectral precoder 220, a subcarrier allocator 230 and a OFDM modulator 240. The Rx includes an OFDM demodulator 250, a subcarrier deallocator 260, a correlative spectral decoder 270 and a data receiver 280.

The data generator 210 is configured to provide an input symbol vector d. The correlative spectral precoder 220 includes a precoding matrix G, which is a lower triangular band matrix with a correlative bandwidth B, and the correlative spectral precoder 220 performs a spectral precoding operation on the input symbol vector d according to the precoding matrix G, in order to generate a precoded symbol vector b. The precoded symbol vector b includes a plurality of vector elements, and the vector elements are correlative with each other. The precoded symbol vector b satisfies the equation: b=G×d. The subcarrier allocator 230 is configured to perform an interleaved subcarrier allocation for the precoded symbol vector b according to a subcarrier allocation matrix, in order to generate a data transmission vector x. The OFDM modulator 240 is configured to generate a transmission signal s(t) in a transmission period, so as to transmit the data vector x. When the Tx satisfies a single-user orthogonal frequency division multiple access (OFDMA) protocol, the baseband power spectral density S(f) of the transmission signal s(t) satisfies the following equation:

$$S ( f ) = \frac{{ρ}^{2} T}{2} {\sum }_{u = 0}^{U - 1} sin {c}^{2} ( {z}_{u} ) {\vert {\sum }_{k = 0}^{∞} {{Q}^{k} ( 1 + {2}^{- I} )}^{k} {z}_{u}^{- k} {D}_{m}^{( k )} \vert}^{2}$$

where zᵤ is a linear function of the frequency f, and Dₘ^{(k)} is related to the precoding matrix G as Dₘ^{(k)}=Σₙ₌₀^{P-1}G_{n,m}n^{k}. When the precoding matrix G satisfies the constraint 1: Dₘ^{(k)}=0 for all mε{0, 1, . . . , M−1}, kε{0, 1, . . . , L−1}; Dₘ^{(L)}≠0 for some m, S(f), can then be further expressed as:

$$S ( f ) = \frac{{ρ}^{2} T}{2 {π}^{2}} {\sum }_{u = 0}^{U - 1} {sin}^{2} ( π {z}_{u} ) {\sum }_{k = 0}^{∞} {{Q}^{2 L + k} ( 1 + {2}^{- I} )}^{2 L + k} {z}_{u}^{- ( 2 L + 2 + k )} {Δ}_{k}$$

where the spectral coefficient Δₖ can be expressed as Δₖ=Σₖ_{₁}₊ₖ_{₂}_{=2L+k}^{k}^{¹}^{,k}^{²}^{≧L}Σₘ₌₀^{M-1}Dₘ^{(k}^{¹}⁾Dₘ^{(k}^{²}⁾. According to the above equation, the OFDMA signal transmitted from the transmitter circuit has power spectral sidelobes decaying as f^{-2L-2}.

Furthermore, the spectral coefficient Δₖ includes a dominant spectral coefficient Δ₀. According to the above equation, the dominant spectral coefficient Δ₀ is a dominating coefficient of the spectral sidelobe decay rate of the baseband power spectral density function S(f), and the precoding matrix G of the correlative spectral precoder designed in the present invention must not only satisfy the above constraint 1, but also let the dominant spectral coefficient Δ₀ achieve the minimum value, so as to further minimize the slowest decaying component (decaying as f^{-2L-2}) of the baseband power spectral density S(f). As shown in FIG. 2C, the transmitter circuit of a spectrally precoded IOFDMA system, which uses a correlative spectral precoder to suppress the spectral sidelobes, is illustrated according to an embodiment of the present invention. Compared with the IOFDMA system of the prior art, because the slowest decaying component (decaying as f^{-2L-2}) of the baseband power density function S(f) of the invented correlatively precoded IOFDMA signal is minimized, the effect of the spectral sidelobes is minimized. Therefore, the present invention can provide the better ability to suppress the spectral sidelobes than the correlative spectral precoder of the prior art.

Furthermore, in the IOFDMA system, the precoding matrix G of the correlative precoder is a lower triangular band matrix with a correlative bandwidth B. That is, in the precoding matrix G of the correlative precoder, except for the main diagonal entries and the (B−1) entries below the main diagonal of the matrix are non-zero, the enteries are all zero, which is shown as belows:

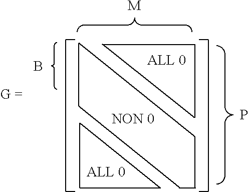

For example, when M=4, P=5 and B=2, the precoding matrix G is as follows:

$$G [ \begin{matrix}{G}_{0 , 0} & 0 & 0 & 0 \\ {G}_{1 , 0} & {G}_{1 , 1} & 0 & 0 \\ 0 & {G}_{2 , 1} & {G}_{2 , 2} & 0 \\ 0 & 0 & {G}_{2 , 3} & {G}_{3 , 3} \\ 0 & 0 & 0 & {G}_{4 , 3}\end{matrix} ]$$

In the correlative spectral precoder of the prior art, the relation between of M, P, B and L is set to M=P−L and B=L+1. M, P are the matrix sizes of the precoding matrix G, and the correlative bandwidth B is a width of the nonzero entries of the precoding matrix G.

In view of the foregoing, the dominant spectral coefficient Δ₀ can be represented as Δ₀=Σₘ₌₀^{M-1}Dₘ^{(L)}Dₘ^{(L)}, where Dₘ^{(L)}=Σₙ₌₀^{P-1}G_{n,m}n^{L} is related to the precoding matrix G, and the precoding matrix G is also related to the correlative bandwidth B. The precoding matrix G, which is different from the correlative spectral precoder of the prior art, can be designed by changing the value of the correlative bandwidth B, so as to further adjust the dominant spectral coefficient Δ₀ to achieve the minimum value. For example, by adjusting the coefficients G_{0,0}, G_{1,0}, G_{1,1}, G_{2,1}, G_{2,2}, G_{3,2}, G_{3,3}, G_{4,3} of the precoding matrix G row by row, the dominant spectral coefficient Δ₀ can achieve the minimum value. Moreover, according to the power spectral density S(f), when the dominant spectral coefficient Δ₀ achieves the minimum value, the slowest decaying component (decaying as f^{-2L-2}) is also minimized, so that it may have the advantage of providing a better power spectral sidelobe suppression capability.

Furthermore, compared with the correlative precoder of the prior art, the correlative precoder in this embodiment changes the relations between M, P, B and L into M=P−L and B=L+2 by increasing the correlative bandwidth B. Specifically, the number of nonzero entries of the correlative precoding matrix G is adjusted from B=L+1 for the prior art into B=L+2 for the embodiment of the present invention. Thus, it has larger degree of freedom for the correlative precoder to adjust the coefficients of the precoding matrix G, so as to further adjust the dominant spectral coefficient Δ₀ to achieve the minimum value. In this invention, the dominant spectral coefficient Δ₀ is achieved when the coefficients of the precoding matrix G are defined as follows:

$${G}_{m + l , m} = \{ \begin{matrix}{( \begin{matrix}2 L + 2 \\ L + 1\end{matrix} )}^{- \frac{1}{2}} {( - 1 )}^{m + 1} ( \begin{matrix}L + 1 \\ l\end{matrix} ) & l ∈ \{ 0 , 1 , … , L + 1 \} and m ∈ \{ 0 , 1 , … , P - L - 2 \} \\ {( \begin{matrix}2 L \\ L\end{matrix} )}^{- \frac{1}{2}} {( - 1 )}^{m + l} ( \begin{matrix}L \\ l\end{matrix} ) & l ∈ \{ 0 , 1 , … , L \} and m = P - L - 1 \} \\ 0 & otherwise\end{matrix}$$

It can be proved that, among the correlative precoders which satisfy the constraint 1, the precoding matrix G of this embodiment can make the dominant spectral coefficient Δ₀ achieve its minimum value. That is, even though the correlative bandwidth (number of nonzero entries) B of the precoding matrix G is further increased, it is still unable to let the dominant spectral coefficient Δ₀ become smaller. Thus, in this embodiment, the correlative bandwidth is set to B=2.

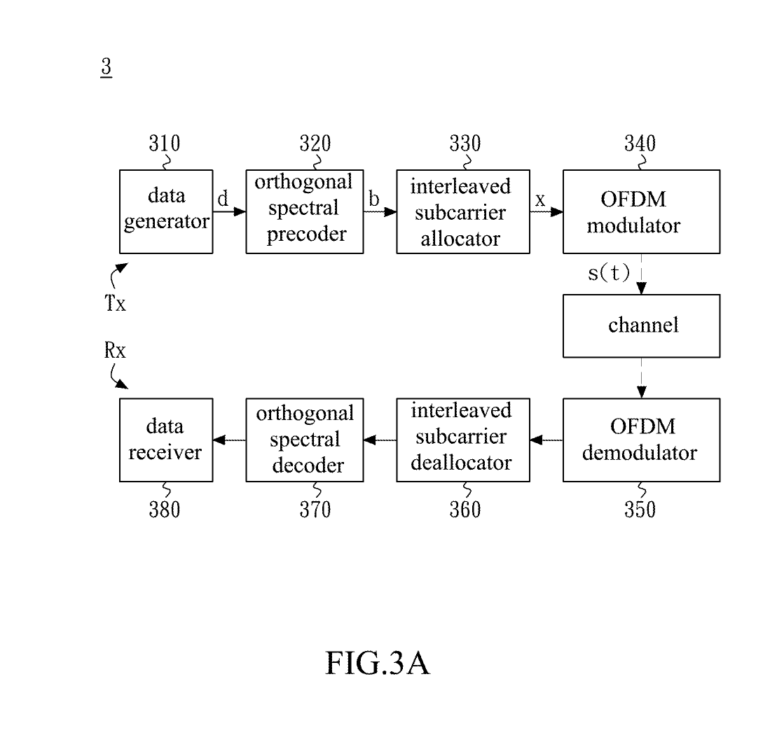

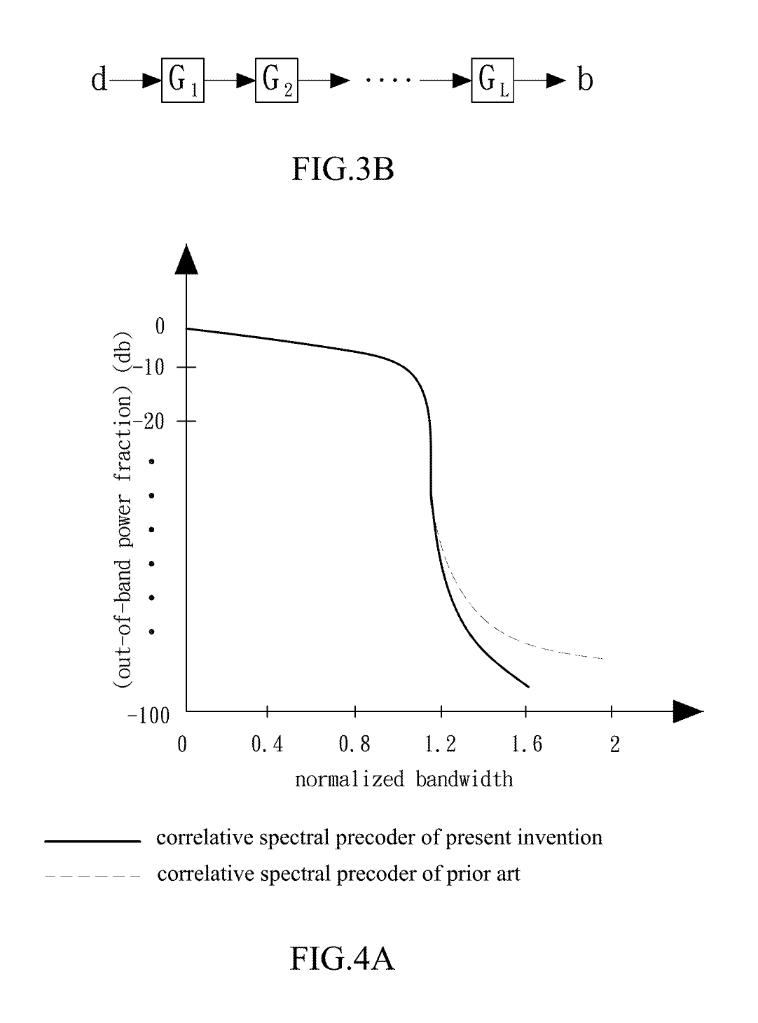

Referring to FIG. 3A, a block diagram of another spectrally precoded IOFDMA system is illustrated. The IOFDMA system 3 includes a channel, a transmitter circuit Tx and a receiver circuit Rx. The transmitter circuit Tx includes a data generator 310, an orthogonal spectral precoder 320, a subcarrier allocator 330 and an OFDM modulator 340. The receiver circuit Rx includes an OFDM demodulator 350, a subcarrier deallocator 360, an orthogonal spectral decoder 370 and a data receiver 380.

The data generator 310 is configured to provide an input symbol vector d. The orthogonal precoder 320 is configured to perform a spectrally precoding operation on the input symbol vector d according to a plurality of subprecoding matrices Gₖ, kε{1, 2, . . . , L}, so as to generate a precoded symbol vector b. The column vectors of the subprecoding matrices Gₖ are orthogonal to each other, that is to say, Gₖ^{h}Gₖ=I, and the precoded symbol vector b satisfies the relation: b=G×d=G_{L}×G_{L-1}× . . . ×G₁×d. The subcarrier allocator 330 is configured to perform an interleaved subcarrier allocation for the precoded symbol vector b according to a subcarrier allocation matrix, in order to generate a data transmission vector x. The OFDM modulator 340 is configured to generate a transmission signal s(t) in a transmission period, so as to transmit the data vector x.

When the transmitter circuit satisfies a single-user orthogonal frequency division multiple access (OFDMA) protocol, the baseband power spectral density S(f) of transmission signal s(t) satisfies the following equation:

$$S ( f ) = \frac{{ρ}^{2} T}{2} {\sum }_{u = 0}^{U - 1} sin {c}^{2} ( {z}_{u} ) {\vert {\sum }_{k = 0}^{∞} {{Q}^{k} ( 1 + {2}^{- I} )}^{k} {z}_{u}^{- k} {D}_{m}^{( k )} \vert}^{2}$$

where zᵤ is a linear function of the frequency f, and Dₘ^{(k)}=Σₙ₌₀^{P-1}G_{n,m}n^{k} is related to the equivalent precoding matrix G=G_{L}×G_{L-1}× . . . ×G₁. When the plurality of the subprecoding matrices G₁˜G_{L} satisfy a constraint 2: (Π_{k=L}^{L-l+1}Gₖ)^{t}eₗ₋₁=0, where eₗ is a constraint vector defined by eₗ=[0^{l}, 1^{l}, . . . , (P−1)^{l}]^{t}, for all lε{1, 2, . . . , L}, the equivalent precoding matrix G will satisfy the constraint 1: Dₘ^{(k)}=0 for all mε{0, 1, . . . , M−1}, kε{0, 1, . . . , L−1}; for some m. Accordingly, the above S(f) can further be represented as:

$$S ( f ) = \frac{{ρ}^{2} T}{2 {π}^{2}} {\sum }_{u = 0}^{U - 1} {sin}^{2} ( π {z}_{u} ) {\sum }_{k = 0}^{∞} {{Q}^{2 L + k} ( 1 + {2}^{- I} )}^{2 L + k} {z}_{u}^{- ( 2 L + 2 + k )} {Δ}_{k}$$

where the spectral coefficient Δₖ is given by Δₖ=Σₖ_{₁}₊ₖ_{₂}_{=2L+k}^{k}^{¹}^{,k}^{²}^{≧L}Σₘ₌₀^{M-1}Dₘ^{(k}^{¹}⁾. According to the above equation, the OFDMA signal, generated from the transmitter circuit, has spectral sidelobes decaying as f^{-2L-2}.

The main difference between the above embodiment and the prior art is that the embodiment of the present invention uses an orthogonal spectral precoder 320 to perform a special decomposition on a high-complexity precoding matrix G. That is to say, the spectrally precoding operation is performed on the input symbol vector d by a plurality of low-complexity subprecoding matrices G₁˜G_{L} instead of a high-complexity precoding matrix G. Thus, compared with the prior art, which uses a single high-complexity precoding matrix G to perform the spectrally precoding operation on the input symbol vector d, the present embodiment can achieve the purpose of simple design and low complexity.

Furthermore, the orthogonal spectral precoder 320 of the present invention decomposes the precoding matrix G into a plurality of low-complexity subprecoding matrices G₁˜G_{L}. The low complexity, herein, means that the entries of the matrix include more entries which are 0 or 1. Thus, when the multiplier performs the matrix multiplication operations, there is no need of using the multiplier for the entries 0 or 1, so that the use of the multiplier can be substantially simplified.

For example, if

$${G}_{1} = [ \begin{matrix}0 & 0 & 0 & 0 & \frac{- 2}{\sqrt{5}} & \frac{- 4}{\sqrt{105}} \\ 0 & 0 & 0 & 0 & \frac{1}{\sqrt{5}} & \frac{- 8}{\sqrt{105}} \\ 1 & 0 & 0 & 0 & 0 & 0 \\ 0 & 0 & 0 & 0 & 0 & \frac{5}{\sqrt{105}} \\ 0 & 1 & 0 & 0 & 0 & 0 \\ 0 & 0 & 1 & 0 & 0 & 0 \\ 0 & 0 & 0 & 1 & 0 & 0\end{matrix} ]$$

$${G}_{2} = {2}^{- 3 / 2} [ \begin{matrix}1 & 1 & 1 & 1 & 1 & 1 & 1 \\ - 1 & 1 & - 1 & 1 & - 1 & 1 & - 1 \\ 1 & - 1 & - 1 & 1 & 1 & - 1 & - 1 \\ - 1 & - 1 & 1 & 1 & - 1 & - 1 & 1 \\ 1 & 1 & 1 & - 1 & - 1 & - 1 & - 1 \\ - 1 & 1 & - 1 & - 1 & 1 & - 1 & 1 \\ 1 & - 1 & - 1 & - 1 & - 1 & 1 & 1 \\ - 1 & - 1 & 1 & - 1 & 1 & 1 & - 1\end{matrix} ] ,$$

the equivalent precoding matrix will be shown as G=G₂×G₁. According to the content of the subprecoding matrices G₁, G₂, it can be understood that as it only needs to perform the multiplication operation between five entries

$$\frac{- 2}{\sqrt{5}} , \frac{1}{\sqrt{5}} , \frac{- 4}{\sqrt{105}} , \frac{- 8}{\sqrt{105}} , \frac{5}{\sqrt{105}}$$

of the subprecoding matrix G₁ and the entry 2^{-3/2} of the subprecoding matrix G₂, therefore it only takes six multiplications to complete the operation.

As shown in FIG. 3B, a multiple-stage precoding structure is illustrated. The precoding matrix includes a plurality of subprecoding matrices G₁˜G_{L}. Each subprecoding matrix represents one stage. That is, a plurality of subprecoding matrices Gₖ include stages one to L. The subprecoding matrix G_{L} is the last stage subprecoding matrix and is a 2^{p}×(2^{p}−1) reduced Hadamard matrix. That is, the subprecoding matrix G_{L} is a known constant matrix. Therefore, because the subprecoding matrices G₁˜G_{L} must satisfy the constraint 2: for l=2, G_{L}G_{L-1})^{t}e₁=0, the previous stage precoding matrix G_{L-1} can be calculated by the known subprecoding matrix G_{L}. Then, according to the constraint 2 for l=3, which is given by (G_{L}G_{L-1}G_{L-2})^{t}e₂=0, the previous two stage subprecoding matrix G_{L-2} can be calculated. Accordingly, each stage subprecoding matrix G₁˜G_{L} can be calculated progressively. In other words, each stage subprecoding matrix G_{L-l+1} can be calculated progressively according to constraint 2 for l=2˜L.

Furthermore, the orthogonal spectral precoder 320 of the present invention decomposes the precoding matrix G into a plurality of low-complexity subprecoding matrices Gₖ, and each subprecoding matrix can be calculated by the following procedure 1. In step 1, the given known subprecoding matrix G_{L} is a 2^{p}×(2^{p}−1) reduced Hadamard matrix. In step 2, by considering the constraint 2 for l=2, (G_{L}G_{L-1})^{t}e₁=0 can be obtained, and thus the previous subprecoding matrix G_{L-1} can be calculated accordingly. Similarly, in step l, by considering the constraint 2 for l=l, (Π_{k=L}^{L-l+1}Gₖ)^{t}eₗ₋₁=0 can be obtained, and thus the subprecoding matrix G_{L-l+1} can be calculated. When it comes to step l=L, by considering the constraint 2 for l=L, (Π_{k=L}¹Gₖ)^{t}e_{L-1}=0 can be obtained, and thus the first stage subprecoding matrix G₁ can be obtained.

In the above procedure 1, the most important part is to solve (Π_{k=L}^{L-l+1}Gₖ)^{t}eₗ₋₁=0 for G_{L-l+1}, when the subprecoding matrices G_{L}˜G_{L-l+2} are given in step l, and the obtained subprecoding matrix G_{L-l+1} must be arranged to include a plurality of entries 0 or 1, in order to achieve the effect of low complexity. Thus, if we set X=G_{L-l+1} and v=(Π_{k=L}^{L-l+2}Gₖ)^{t}eₗ₋₁, the problem is equivalent to solve R×(R−1) matrix X, which satisfies X^{t}v=0, with the given R×1 vector v. That is, the subprecoding matrix G_{L-l+1}, having lots of entries 0 or 1, can be solved by this equivalent equation. In the embodiments of the present invention, there are two methods for solving the matrix X, including one method using the vector v with the entry 0 and the other method using the vector v without the entry 0.

The first method for solving the matrix X is that when the vector v does not include the entry 0, the matrix X can be obtained by the below solving procedure 2. In step 0, a diagonal matrix M₀=[m₀⁽⁰⁾, m₁⁽⁰⁾, . . . , mₖ_{₀}₋₁⁽⁰⁾] is defined, where mₙ⁽⁰⁾ denotes the nth column vector of M₀, and the kth diagonal entry of M₀ is the kth entry of the vector v.

In step 1, define M₁=[m₀⁽¹⁾, m₁⁽¹⁾, . . . , mₖ_{₁}₋₁⁽¹⁾], Y₁=[y₀⁽¹⁾, y₁⁽¹⁰, . . . , yₖ_{₀}₋ₖ_{₁}₋₁⁽¹⁾], where k₁=┌k₀/2┐, mₙ⁽¹⁾ denotes the nth column vector of M₁, and yₙ⁽¹⁾ denotes the nth column vector of Y₁, and both satisfy the following equations:

$$\{ \begin{matrix}{m}_{n}^{( 1 )} = {m}_{2 n}^{( 0 )} + {m}_{2 n + 1}^{( 0 )} & for n = 0 , 1 , … , {k}_{1} - 1 & when {k}_{0} is even \\ {m}_{n}^{( 1 )} = {m}_{2 n}^{( 0 )} + {m}_{2 n + 1}^{( 0 )} & for n = 0 , 1 , … , {k}_{1} - 2 & and {m}_{{k}_{1} - 1}^{( a )} = {m}_{{k}_{0} - 1}^{( a - 1 )} \\ {y}_{n}^{( 1 )} = {‖ {m}_{2 n + 1}^{( 0 )} ‖}^{2} {m}_{2 n + 1}^{( 0 )} - {‖ {m}_{2 n}^{( 0 )} ‖}^{2} {m}_{2 n + 1}^{( 0 )} & for n = 0 , 1 , … , {k}_{0} - {k}_{1} - 1 & when {k}_{0} is odd\end{matrix}$$

Similarly, in step a, define Mₐ=[m₀^{(a)}, m₁^{(a)}, . . . , mₖ_{ₐ}₋₁^{(a)}], Yₐ=[y₀^{(a)}, y₁^{(a)}, . . . , y^{k}ₐ₋₁₋ₖ_{ₐ}₋₁^{(a)}], where kₐ=┌kₐ₋₁/2┌, mₙ^{(a)} denotes the nth column vector of Mₐ, and yₙ^{(a)} denotes the nth column vector of Yₐ, and both satisfy the following equations:

$$\{ \begin{matrix}{m}_{n}^{( a )} = {m}_{2 n}^{( a - 1 )} + {m}_{2 n + 1}^{( a - 1 )} & for n = 0 , 1 , … , {k}_{a} - 1 & when {k}_{a - 1} is even \\ {m}_{n}^{( a )} = {m}_{2 n}^{( a - 1 )} + {m}_{2 n + 1}^{( a - 1 )} & for n = 0 , 1 , … , {k}_{a} - 2 & and {m}_{{k}_{a} - 1}^{( a )} = {m}_{{k}_{a - 1} - 1}^{( a - 1 )} \\ {y}_{n}^{( a )} = {‖ {m}_{2 n + 1}^{( a + 1 )} ‖}^{2} {m}_{2 n + 1}^{( a - 1 )} - {‖ {m}_{2 n}^{( a - 1 )} ‖}^{2} {m}_{2 n + 1}^{( a - 1 )} & for n = 0 , 1 , … , {k}_{a - 1} - {k}_{a} - 1 & when {k}_{a - 1} is odd\end{matrix}$$

Repeating step until a=A, where A satisfies 2^{A-1}<R≦2^{A}, and R is the number of entries in v. In the step A+1, let matrix X be the normalization of the matrix [Y₁, Y₂, . . . , Y_{A}], and then the matrix X can be obtained.

The second method is used for solving the matrix X when the vector v includes the entry 0. In the case, the matrix X can be determined by the following procedure 3. In the step 1, a matrix P is found to satisfy Pv=[0^{t},w^{t}]^{t}, where the vector w does not include the entry 0. In step 2, a matrix Z is found by the procedure 2, so as to satisfy Z^{t}w=0. In step 3, the matrix X is obtained by

$$X = {P}^{′} [ \begin{matrix}I & O \\ O & Z\end{matrix} ] ,$$

where I is the identity matrix.

According to the procedures 2 and 3, if the vector v includes D entries 0, the matrix X at most has (R−D)log₂(R−D) entries that are not 0 or 1. That is, after using the above orthogonal precoding matrix of the present invention, the subprecoding matrices G₁˜G_{L-1} can include many 0 or 1 entries, so that the use of the multipliers is reduced

Thus, according to the above the precedures 2 and 3, the multiple-stage subprecoding matrices G₁˜G_{L} can be obtained. In addition, if the subprecoding matrix has more stages, L is getting bigger and it can provide power spectral sidelobes decaying as fast as f^{2L-2}, but the complexity of the precoding matrix will be increased accordingly.

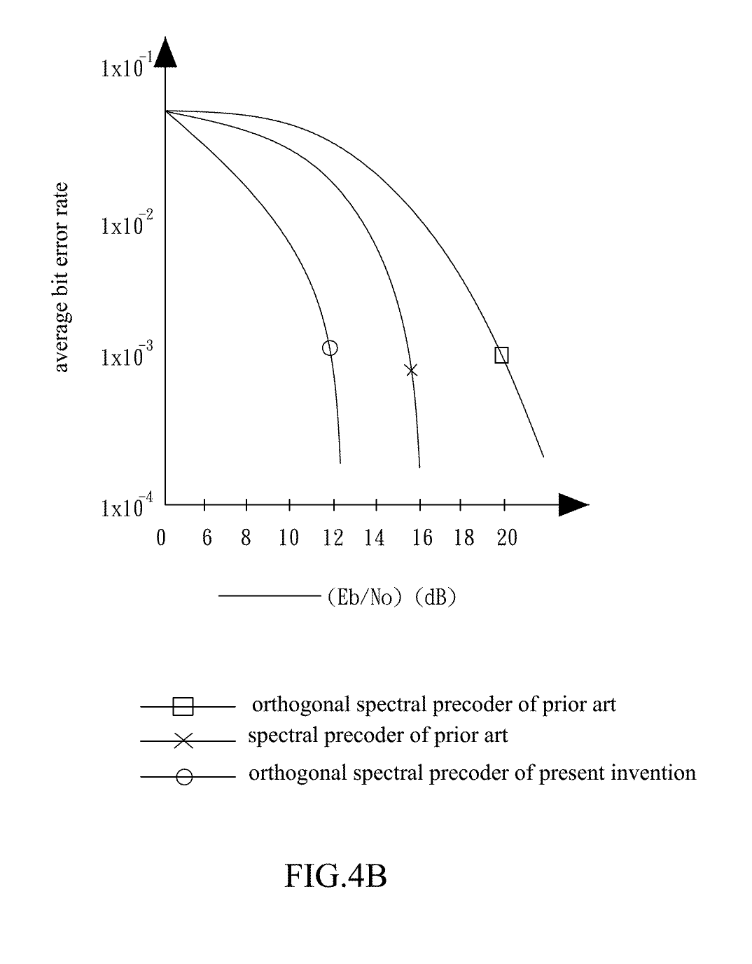

Please referring to FIG. 4A, a comparison chart for the out-of-band power fraction between the correlative spectral precoder of the prior art and the correlative spectral precoder of the present invention. According to FIG. 4A, the IOFDMA transmitter circuit using the invented correlative spectral precoder can provide smaller power spectral sidelobes than the IOFDMA transmitter circuit using the correlative spectral precoder of the prior art. Please referring to FIG. 4B, a comparison chart of the average bit error rate between the spectral precoder of the prior art and the orthogonal spectral precoder of the present invention. According to FIG. 4B, the IOFDMA transmitter circuit using the invented orthogonal spectral precoder not only reduces the complexity of the precoding matrix, but also has a lower bit error rate than the IOFDMA transmitter circuit using the spectral precoders of the prior art.

In view of the foregoing, with the use of a transmitter circuit for spectrally precoded orthogonal frequency division multiple access with interleaved subcarrier allocation, the IOFDMA transmission system includes a correlative or an orthogonal spectral precoder, configured to perform a precoding operation on the data symbols which are generated from the data generator, in order to generate the precoded symbols. The IOFDMA transmitter circuit of this embodiment can use the above correlative and orthogonal spectral precoder to perform the precoding operation, so that the IOFDMA transmission system of the present invention can construct signals with power spectral sidelobes decaying as f^{-2L-2}, where f denotes frequency. Accordingly, compared to the conventional IOFDMA transmission system, the IOFDMA transmitter circuit of the present embodiment has two aspects, which includes a transmitter circuit of the correlative spectral precoder having a better power spectral sidelobe suppression capability and includes a transmitter circuit of the orthogonal spectral precoder with a low-complexity precoding matrix.

Although specific embodiments have been illustrated and described, it will be appreciated by those skilled in the art that various modifications may be made without departing from the scope of the present invention, which is intended to be limited solely by the appended claims.

What is claimed is:

1. A transmission circuit for spectrally precoded orthogonal frequency division multiple access with interleaved subcarrier allocation, comprises:
a data generator, configured to provide an input symbol vector d;
a correlative spectral precoder, including a precoding matrix G which is a lower triangular band matrix with a correlative bandwidth B, wherein the correlative spectral precoder performs a spectral precoding operation on the input symbol vector d according to the precoding matrix G, in order to generate a precoded symbol vector b, wherein the precoded symbol vector b satisfies an equation: b=G×d;
a subcarrier allocator, configured to perform an interleaved subcarrier allocation on the precoded symbol vector b according to a subcarrier allocation matrix, in order to generate a data transmission vector x; and
an OFDM modulator, configured to generate a transmission signal s(t) in a transmission period for transmitting the data vector x;
wherein when the transmitter circuit satisfies a single-user orthogonal frequency division multiple access (OFDMA) protocol, a baseband power spectral density S(f) of the transmission signal s(t) satisfies a following equation:
$$S ( f ) = \frac{{ρ}^{2} T}{2} {\sum }_{u = 0}^{U - 1} sin {c}^{2} ( {z}_{u} ) {\vert {\sum }_{k = 0}^{∞} {{Q}^{k} ( 1 + {2}^{- I} )}^{k} {z}_{u}^{- k} {D}_{m}^{( k )} \vert}^{2}$$
wherein zᵤ is a linear function of the frequency f, and Dₘ^{(k)}=Σₙ₌₀^{P-1}G_{n,m}n^{k} is related to the precoding matrix G;
and when the precoding matrix G satisfies the constraint: for all mε{0, 1, . . . , M−1}, kε{0, 1, . . . , L−1}, Dₘ^{(k)}=0; for some m, Dₘ^{(L)}≠0, S(f) is then further expressed as:
$$S ( f ) = \frac{{ρ}^{2} T}{2 {π}^{2}} {\sum }_{u = 0}^{U - 1} {sin}^{2} ( π {z}_{u} ) {\sum }_{k = 0}^{∞} {{Q}^{2 L + k} ( 1 + {2}^{- I} )}^{2 L + k} {z}_{u}^{- ( 2 L + 2 + k )} {Δ}_{k}$$
wherein the spectral coefficient Δₖ is defined by Δₖ=Σₖ_{₁}₊ₖ_{₂}_{=2L+k}^{k}^{¹}^{,k}^{²}^{≧L}Σₘ₌₀^{M-1}Dₘ^{(k}^{¹}⁾Dₘ^{(k}^{²}⁾; and the transmission signal s(t), which is generated from the transmitter circuit and satisfies the OFDMA protocol, has spectral sidelobes decaying as f^{2L-2}, wherein L is a positive integer.

2. The transmission circuit of claim 1, wherein Δₖ includes a dominant spectral coefficient Δ₀.

3. The transmission circuit of claim 2, wherein the correlative bandwidth B is a number of nonzero entries of each column of the precoding matrix G.

4. The transmission circuit of claim 3, wherein the dominant spectral coefficient Δ₀ is adjusted according to the nonzero entries of each column of the precoding matrix G.

5. A transmission circuit for spectrally precoded orthogonal frequency division multiple access with interleaved subcarrier allocation, comprises:
a data generator, configured to provide an input symbol vector d;
an orthogonal spectral precoder, configured to perform a spectral precoding operation on the input symbol vector d according to a plurality of subprecoding matrices Gₖ, kε{1, 2, . . . , L}, in order to generate a precoded symbol vector b, and column vectors of the subprecoding matrices Gₖ are orthogonal, which satisfy Gₖ^{h}Gₖ=I, and the precoded symbol vector b satisfies an equation: b=G×d=G_{L}×G_{L-1}× . . . ×G₀×d;
a subcarrier allocator, configured to perform an interleaved subcarrier allocation on the precoded symbol vector b according to a subcarrier allocation matrix, in order to generate a data transmission vector x; and
a OFDM modulator, configured to generate a transmission signal s(t) in a transmission period, so as to transmit the data vector x; wherein when the transmitter circuit satisfies a single-user orthogonal frequency division multiple access (OFDMA) protocol, the baseband power spectral density S(f) of the transmission signal s(t) satisfies a following equation:
$$S ( f ) = \frac{{ρ}^{2} T}{2} {\sum }_{u = 0}^{U - 1} sin {c}^{2} ( {z}_{u} ) {\vert {\sum }_{k = 0}^{∞} {{Q}^{k} ( 1 + {2}^{- I} )}^{k} {z}_{u}^{- k} {D}_{m}^{( k )} \vert}^{2}$$
wherein when the subprecoding matrices G₁˜G_{L} satisfies a constraint: (Π_{k=L}^{L-l+1}Gₖ)^{t}eₗ₋₁=0, for all /ε{1, 2, . . . , L}, wherein eₗ=[0^{l}, 1^{l}, . . . , (P−1)^{l}]^{t}; the transmission signal s(t), which is generated from the transmitter circuit and satisfies the OFDMA protocol, has spectral sidelobes decaying as f^{2L-2}, wherein L is a positive integer.

6. The transmission circuit of claim 5, wherein each subprecoding matrix Gₖ represents one stage of the subprecoding matrix, and the subprecoding matrix Gₖ includes stage one to L.

7. The transmission circuit of claim 6, wherein the L-th stage subprecoding matrix G_{L} of the plurality of subprecoding matrices Gₖ is a 2^{P}×(2^{P}−1) reduced Hadamard matrix.

8. The transmission circuit of claim 6, wherein eₗ₋₁ is a constraint vector.

9. The transmission circuit of claim 8, wherein each level subprecoding matrix Gₗ is solved according to the constraint (Π_{k=L}^{L-l+1}Gₖ)^{t}eₗ₋₁=0, for all /ε{1, 2, . . . , L}.
